(19) United States
(12) Patent Application Publication
(10) Pub. No.: US 2026/0264213 A1
(43) Pub. Date: Sep. 10, 2026

(54) TOOL STORAGE ACCESSORY SYSTEM

(71) Applicant: VIS, LLC, Greer, SC (US)

(72) Inventors: Nicholas Latronica, Taylors, SC (US); Quinlan Smith, Greenville, SC (US); Timothy Brewster, Greer, SC (US); Josh Holley, Taylors, SC (US); Patrick Livingston, Campobello, SC (US)

(73) Assignee: VIS, LLC, Greer, SC (US)

(21) Appl. No.: 19/071,455

(22) Filed: Mar. 5, 2025

(51) Int. Cl. B25H 3/02; B25H 5/00; B62B 3/00; B62B 5/00; B62B 5/06

(52) U.S. Cl. CPC B25H 3/028; B25H 5/00; B62B 3/005; B62B 5/0003; B62B 5/06; B62B 2202/023; B62B 2202/48

(57) ABSTRACT

A mobile toolbox system includes rails having apertures formed therein, the apertures being sized and positioned to receive complementary, positionable accessories for holding various components such as a phone holder, a hook, a towel bar, a power tool holder, a parts holder, a spool holder, and a cup holder.

### BACKGROUND OF THE DISCLOSURE

Vehicle repair, maintenance, and service facilities as well as home garages use a variety of tools and related equipment to service vehicles or to repair machinery, devices, and the like. Needed tools typically are stored in a toolbox that is positioned near the vehicle or device being serviced. However, many tools and related items do not fit easily within standard toolboxes, or the items cannot be readily accessed while servicing the vehicle. Still further, a technician or mechanic may also have a personal phone, a coffee cup, and sundry items that the technician usually places on the toolbox while attending to the vehicle or item being serviced. This arrangement and approach suffer from a variety of drawbacks.

If, for instance, a power tool is being used, the technician will often place it on top of toolbox when not in use. Likewise, the technician's coffee cup or other drink will be placed on the ground, the vehicle, or the toolbox. Unless the items are placed out of reach or back in the toolbox after each use, they can easily become tripping hazards or can be easily knocked off the toolbox and cause spills and damage.

What is needed in the industry is a toolbox that permits storage of tools but also externally accommodates a variety of accessories for easy access during vehicle maintenance.

### BRIEF SUMMARY OF THE DISCLOSURE

The present disclosure is directed to a system of accessories that mount onto the side of toolboxes or carts for holding tools, cups, and the like. The system has mountable, configurable accessories to accommodate individual preferences and job requirements. The accessories include but are not limited to a cup holder, a power tool holder, a phone holder, hooks, and a spool holder. The adjustable accessories permit a technician to store objects that do not typically fit within the toolbox and for toolbox customization to move the accessories to various positions around the cart for different tasks.

In one embodiment according to the disclosure, the system utilizes a set of rails bolted to corners of a tool cart. The rails may be steel or other hardened material with a series of slots that function as mounting locations for the accessories. The slots may be equally spaced to universally receive various accessories regardless of a location or position of the cart. The accessories may include a bent steel mounting plate as well as a plastic retaining button. The steel mounting plate and plastic retaining button engage the slots to allow for the accessory to be mounted to the tool cart.

According to a method of the disclosure, to attach an accessory to the various slots, a user will push down on the plastic retaining button to first engage a bottom steel mounting plate into one of the slots. Then the accessory is pivoted into place such that the plastic retaining button can be engaged. To remove an accessory, the plastic retaining button is depressed, and the accessory can be pivoted out of the slots.

In another aspect of the disclosure, a mobile toolbox system may include a toolbox having a plurality of wheels attached thereto, the frame being configured for positioning proximate a vehicle; a rail having a plurality of apertures formed therein, the rail disposed proximate a corner of the toolbox; and an accessory having means for connecting the accessory in at least one of the apertures, the accessory being configured to hold an item proximate a perimeter of the toolbox, proximate a perimeter of the toolbox, the accessory being further configurable for repositioning to other apertures on the rail. The rail may be made of steel, and the apertures may be spaced equidistant from each other. Further, the mobile toolbox system may include a tie-down aperture for receiving a strap to secure the toolbox for transporting the toolbox between work sites.

The accessory in this embodiment may be a phone holder, a hook, a towel bar, a power tool holder, a parts holder, a spool holder, a cup holder, and the like, as well as combinations of such accessories. The means for connecting may be button and one or more latches, the button being configured to overcome a spring constant of each latch to urge each of the latches into respective engagement with the apertures.

In another embodiment, a method of customizing a mobile tool cart may include providing a toolbox having a plurality of wheels attached thereto, the toolbox being configured for positioning proximate a vehicle; attaching a rail to the toolbox, the rail having a plurality of apertures formed therein; providing at least one accessory; attaching the accessory to the rail; and placing a component in the accessory.

Also in this embodiment, the rail may be steel and may be affixed to a corner of the toolbox, the rail being further configured to act as a damage guard. Further, the accessory may be a phone holder, a hook, a towel bar, a power tool holder, a parts holder, a spool holder, a cup holder, and the like. Multiple accessories may be attached to the rails.

In yet another embodiment, a mobile toolbox kit may include a toolbox having a plurality of wheels attached thereto, the frame being configured for positioning proximate a vehicle; a rail having a plurality of apertures formed therein and spaced equidistant from each other, the rail disposed proximate a corner of the toolbox; a tie-down aperture formed proximate the plurality of apertures, the tie-down aperture being configured for receiving a tie-down strap for securing the toolbox for transport; and an accessory being connectable in at least one of the apertures, the accessory being configured to hold an item external to the toolbox and being selected from one of a phone holder, a hook, a towel bar, a power tool holder, a parts holder, a spool holder, and a cup holder. In this embodiment, the plurality of apertures may be spaced equidistant from each other with at least two accessories attached to the toolbox apart from each other and the accessory can be repositioned to other apertures on the rail.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a front perspective view of a tool storage accessory system (with exemplary drawers and lids in open positions shown in phantom) according to an aspect of the disclosure;

FIG. 2 is a front elevational view of the tool storage accessory system as in FIG. 1;

FIG. 3 is a rear elevational view of the tool storage accessory system as in FIG. 1;

FIG. 4 is left side, elevational view of the tool storage accessory system as in FIG. 1;

FIG. 5 is right side, elevational view of the tool storage accessory system as in FIG. 1;

FIG. 6 is a top plan view of the tool storage accessory system as in FIG. 1;

FIG. 7 is a bottom plan view of the tool storage accessory system as in FIG. 1;

FIG. 8 is a partial perspective view of the slotted rail of the tool storage accessory system as in FIG. 1, particularly showing an exemplary power tool holder relative to the rail;

FIGS. 9A-9C are partial side views of a slotted rail of the tool storage accessory system as in FIG. 1, particularly showing the power tool holder being installed on the rail;

FIG. 10 is a perspective view of a cord holder that can be used with the slotted rail as shown in FIG. 1;

FIG. 11 is a perspective view of a bar that can be used with the slotted rail as shown in FIG. 1;

FIG. 12 is a perspective view of a cup holder that can be used with the slotted rail as shown in FIG. 1;

FIG. 13 is a perspective view of a parts holder that can be used with the slotted rail as shown in FIG. 1;

FIG. 14 is a perspective view of hook that can be used with the slotted rail as shown in FIG. 1;

FIG. 15 is a perspective view of phone or pad holder, which may be used with the slotted rail as shown in FIG. 1;

FIG. 16 is a front elevational view of another embodiment of a tool storage accessory system according to another aspect of the disclosure;

FIG. 17 is a rear elevational view of the tool storage accessory system as in FIG. 16;

FIG. 18 is a left side, elevational view of the tool storage accessory system as in FIG. 16;

FIG. 19 is a right side, elevational view of the tool storage accessory system as in FIG. 16;

FIG. 20 is a top plan view of the tool storage accessory system as in FIG. 16;

FIG. 21 is a bottom plan view of the tool storage accessory system as in FIG. 16;

FIG. 22 is a front perspective view of the exemplary tool storage accessory system as in FIG. 16, particularly showing various accessories attached to the slotted rail; and

FIG. 23 is a perspective view of an exemplary tool storage accessory system shown in a work environment.

### DETAILED DESCRIPTION OF THE DISCLOSURE

As required, detailed embodiments are disclosed herein; however, the disclosed embodiments are merely examples and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical, engineering, and scientific terms used herein have the same meaning as is commonly understood by one of ordinary skill in the art to which this disclosure belongs. In the event that there is a plurality of definitions for a term, phrase, or acronym herein, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, a phrase such as: “a method involving a, b, and c” means that the method includes at least steps a, b, and c.

Where a list of alternative component terms is used, e.g., “a structure such as ‘a,’ ‘b,’ ‘c,’ ‘d’ or the like,” or “a or b,” such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

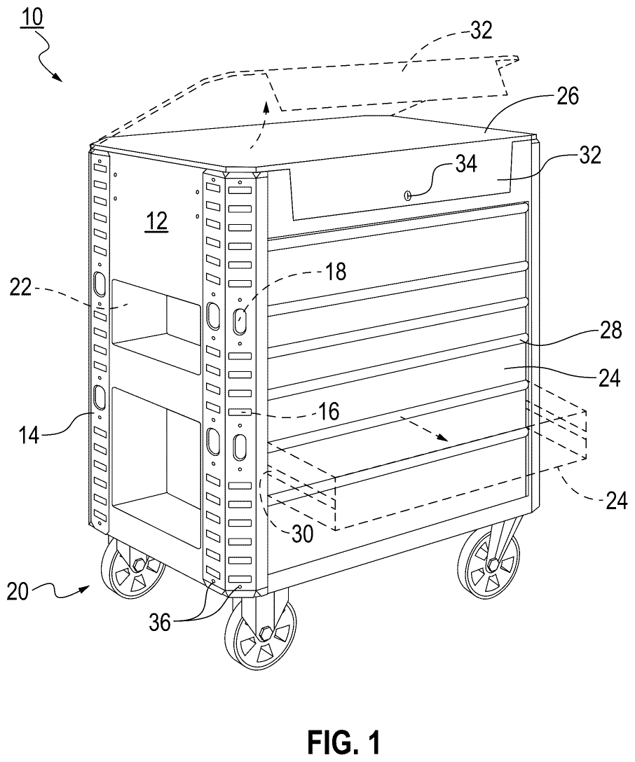

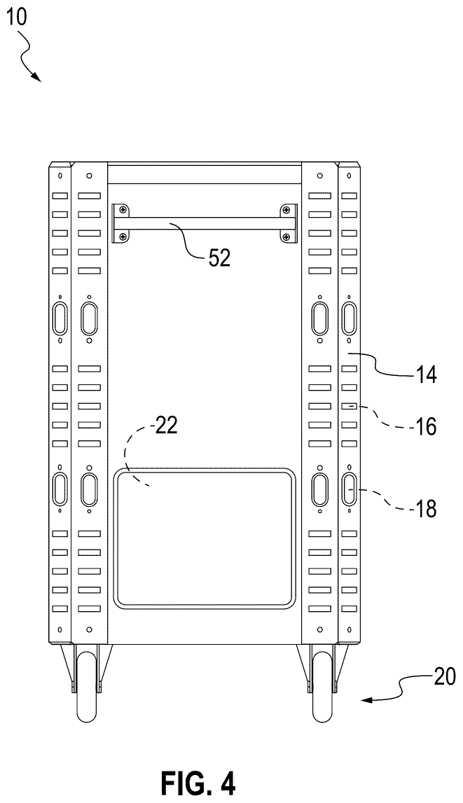

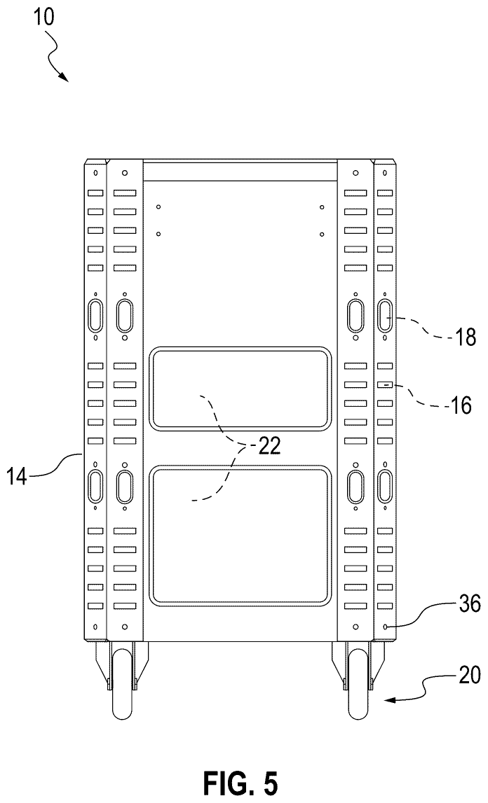

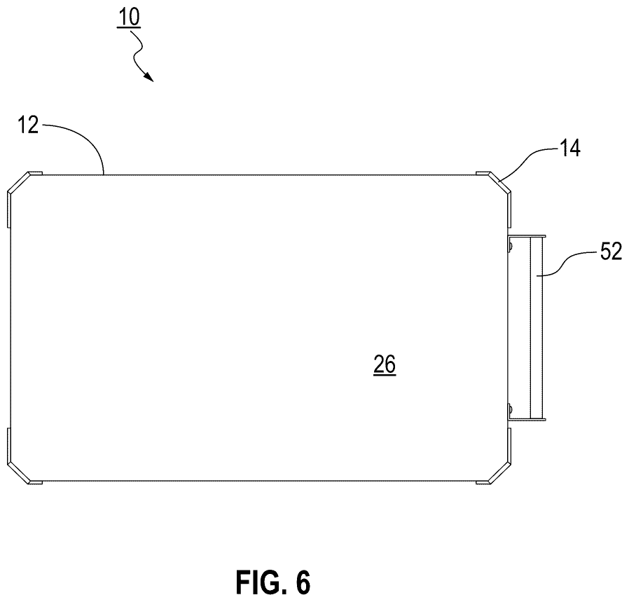

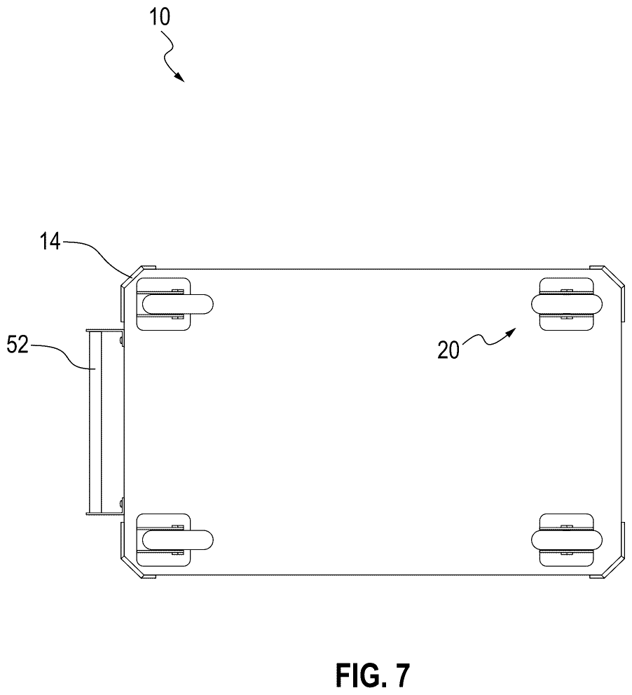

Turning now to FIGS. 1 through 7, a mobile toolbox or tool cart system is broadly designated by the element number 10. The system 10 may include a toolbox 12 with one or more rails 14 having apertures or slots 16 for receiving and holding various components and accessories described below, as well as tie-down apertures 18, also described in further detail below. The toolbox 12 may be mounted on rollers or wheels 20 and have storage shelves, pockets, or areas 22, tool drawers 24, and/or a latchable compartment 26. Here, the tool drawers 24 may include pulls or handles 28 to pull open and close the drawers 24 via rail systems 30 (shown in phantom in FIG. 1 in an open state as indicated with a dashed arrow). Further, the compartment 26 may have a closure, lid, or cover 32 and a lock 34 to protect valuable tools or instrumentation. By locking the lock 34 in this example, both the compartment 26 and the drawers 24 may be secured.

With further reference to the rails 14 in FIGS. 1 through 7, they may be manufactured from steel or other hardened materials capable of withstanding rugged work environments. The rails 14 also may be bolted or permanently affixed to the cart 12, preferably at corners of the cart 12 as shown, for instance, in FIG. 1 with rivets or bolts 36 to assist in protecting the sides and faces of the cart 12 from contact damage, as well as for hanging accessories apart from the tool storage drawers 24 and the lid 32, particularly when the lid 32 is in an open state as shown in phantom in FIG. 1.

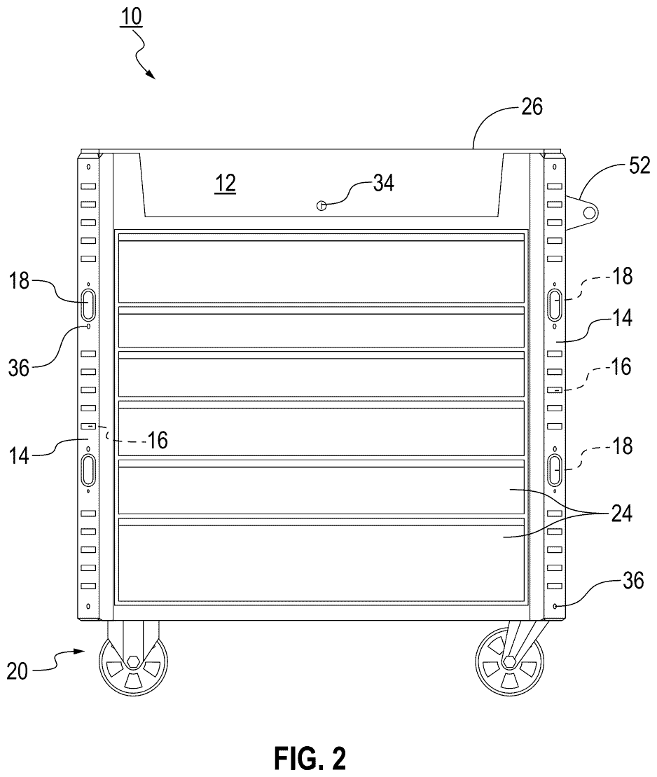

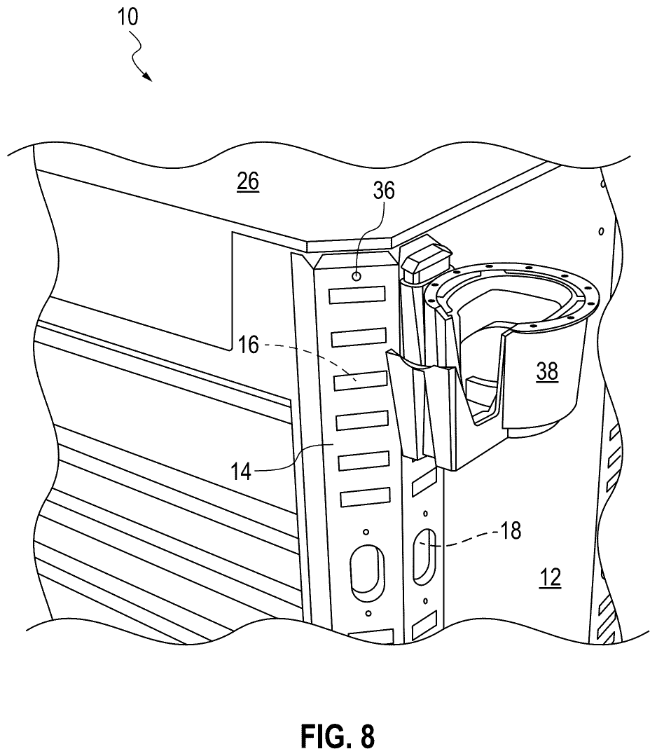

With continued reference to FIG. 1, as well as to FIGS. 2 and 8 through 13, the rails 12 may be mounted onto sides or corners of the steel toolbox 12 and between a handle 52 for configurable quick access, including but not limited to a power tool holder 38, a spool holder 40, a towel bar system 42, a cup holder 44, a parts holder 46 (e.g., for nuts, bolts, screws, and other fasteners), a hook 48, and a phone holder 50. This system 10 permits the technician to find storage for objects that do not typically fit within the toolbox 12, as well as the ability to move the accessories to various positions around the cart 12 to customize them to a particular workspace, job, or individual preferences.

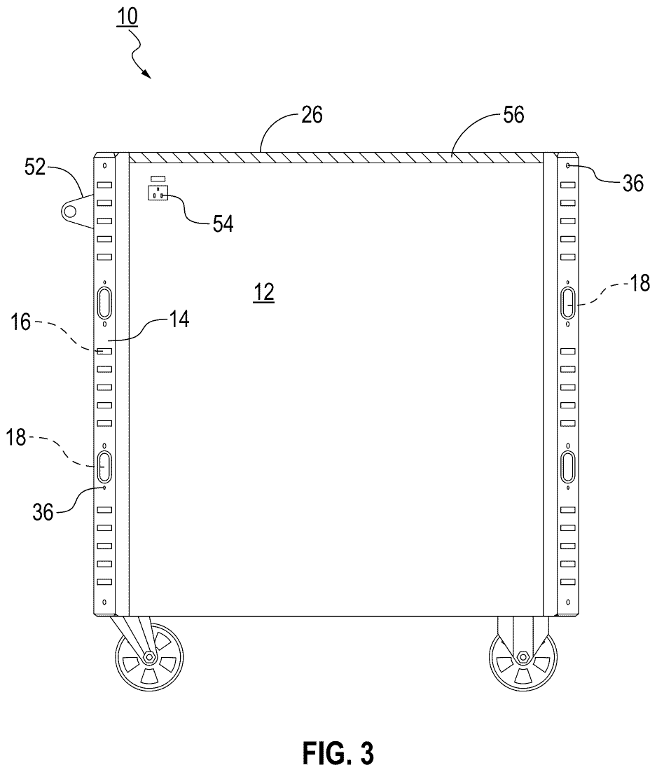

FIG. 3 most clearly shows a rear side of the toolbox 12. A power receptacle 54 is shown below the lid 26, which has a hinge 56 for opening and closing the lid 26 (compare the open state in FIG. 1). The power receptacle 54 permits a user to connect the cart 12 to an external power source (not shown). Additionally, or alternatively, the receptacle 54 can be used to provide power to tools via a battery installed in the cart 12 or to connect the cart to an external power source to, e.g., energize lighting and other optional features within the cart 12.

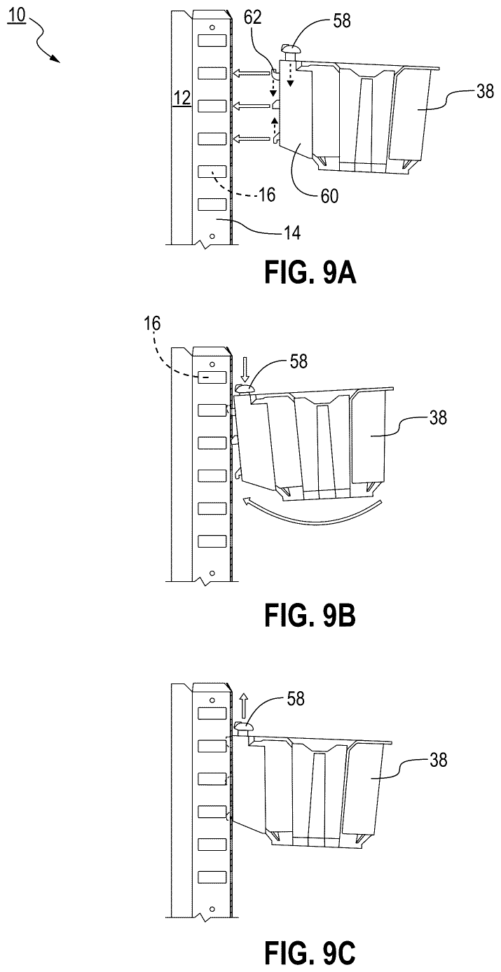

As shown most clearly in FIGS. 9A-9C, the system 10 functions using a set of rails 14 bolted, riveted, or screwed to the corners of the tool cart 12 using screws 36 or the like as introduced above. Here, the rails 14 have a series of equally spaced slots 16 that function as mounting locations for the accessories, such as the power tool holder 38 shown in FIG. 9A. The holder 38, like other universal accessories, may include a retaining button or switch 58 with a steel mounting plate 60 having movable catches or hooks 62 extending in a direction of the slots 16. When the switch 58 is depressed as indicated by the downward arrow, the catches 62 move inwardly as indicated by respective arrows for insertion into the slots 16. When the switch 58 is released, the catches 62 are urged back to their resting open state thereby mounting the accessory into the slots 16 of the tool cart 12. When the user wishes to relocate the holder 38 or other accessory to another area of the cart 12, the procedure using the switch 58 is repeated.

More particularly, as shown in FIG. 9A to attach the holder 38, a user pushes down on the button 58 and engages the catches 62 into the closest slots 16 as indicated by the three horizontal, parallel arrows. Then the holder 38 is pivoted into place as indicated by the curved arrow in FIG. 9B and the button 58 is released as indicated in FIG. 9C. To remove the accessory 38, again the plastic button 58 is depressed, and the accessory 38 can be pivoted out of the slots 16.

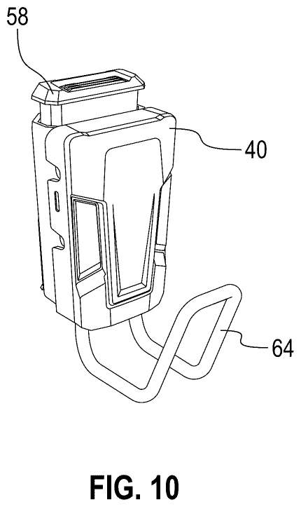

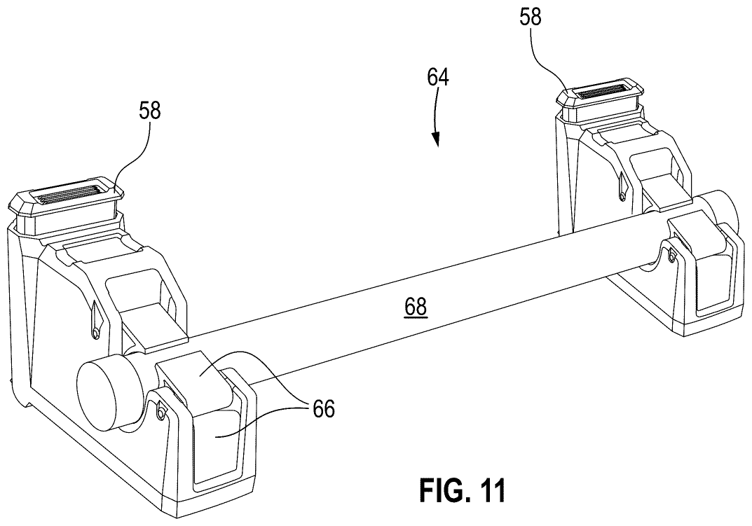

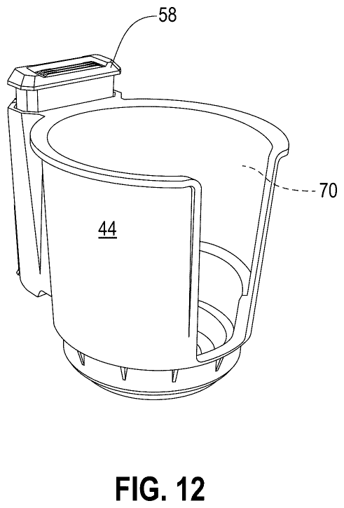

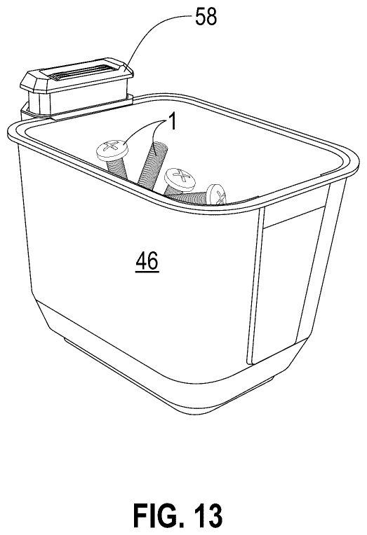

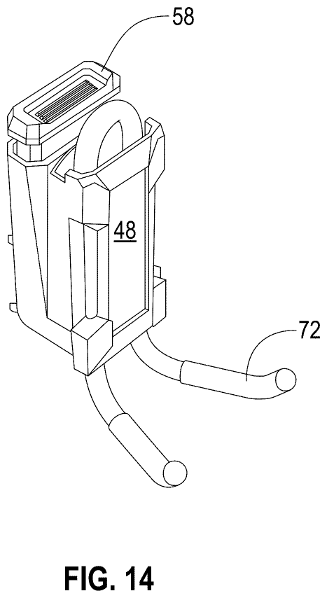

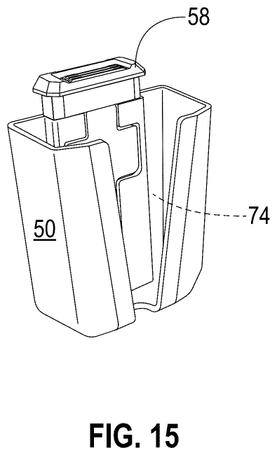

As briefly introduced above, FIG. 10 shows the spool holder 40 with the universal button 58 and a hangar or hook 64; FIG. 11 shows the towel bar system 42 with two universal buttons 58 and a release and latch system 64 for detaching a bar 68 from the towel bar system 42; FIG. 12 shows the cup holder 44 with the universal button 58 and a slot 70 to accommodate a cup handle (not shown); FIG. 13 shows the parts holder 46 for parts 1 such as nuts, bolts, screws, and other fasteners, along with the universal button 58 for adjusting a position of the holder 46 in a manner as described above; FIG. 14 shows the hook device 48 with the universal button 58 and exemplary rubber coated hooks or prongs 72 for hanging electrical cords or the like (not shown); and FIG. 15 shows the phone holder 50 with the universal button 58 and an opening 74 to accommodate protrusions or other items extending from a phone or personal device (not shown).

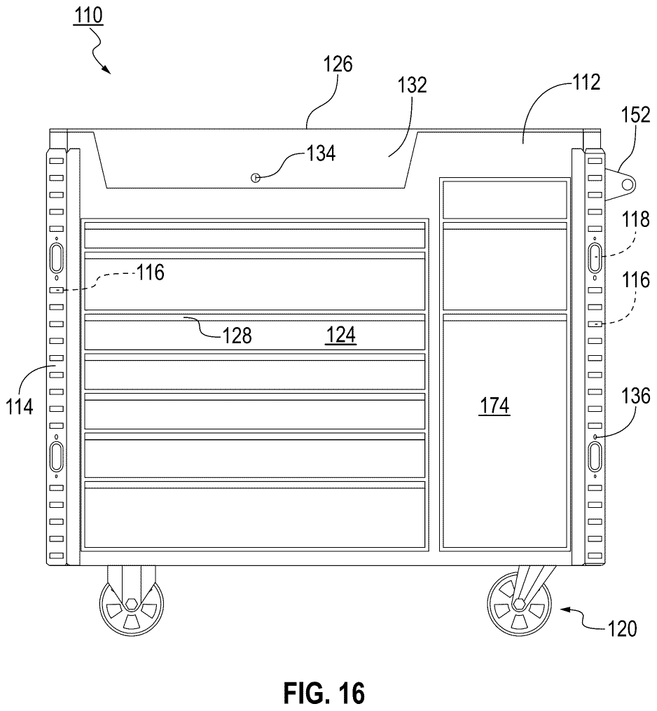

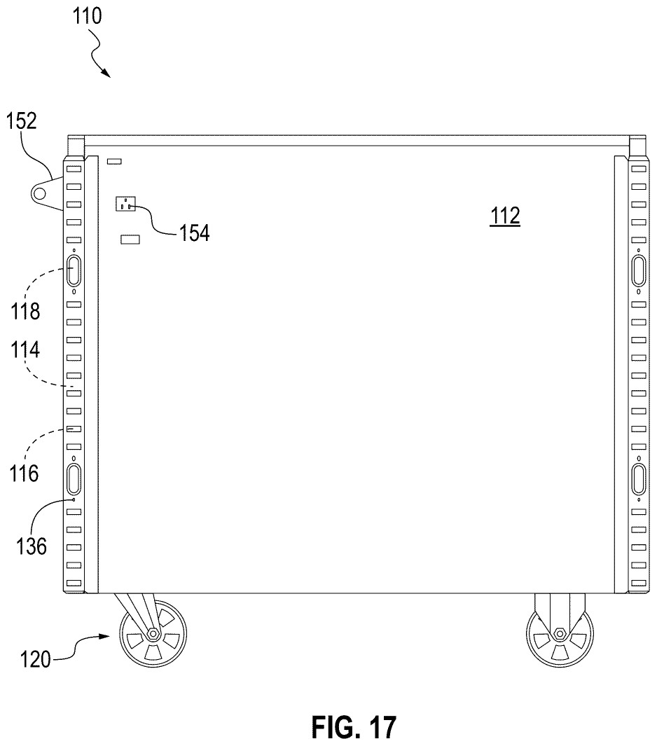

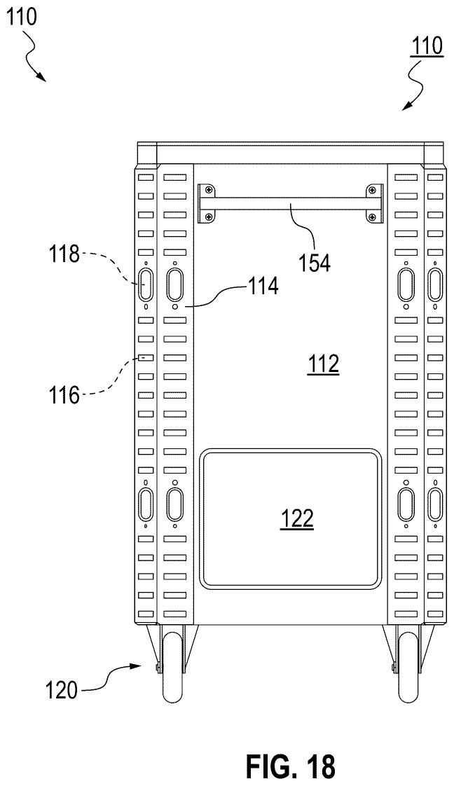

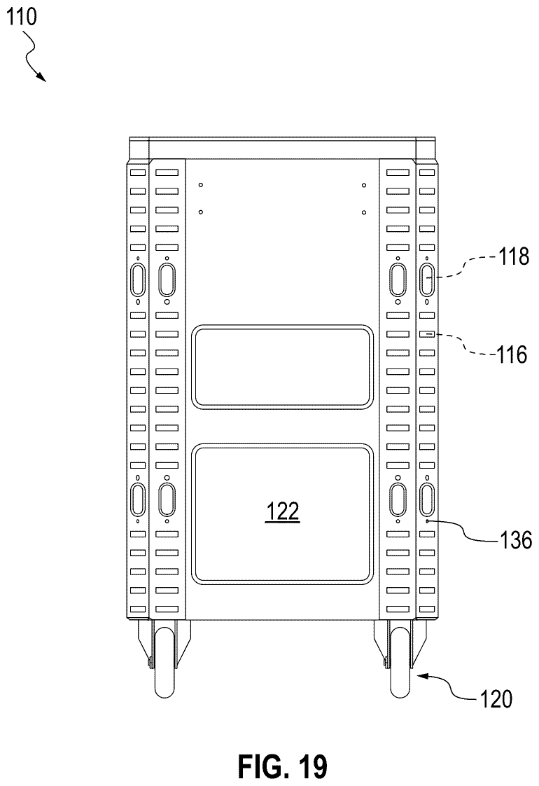

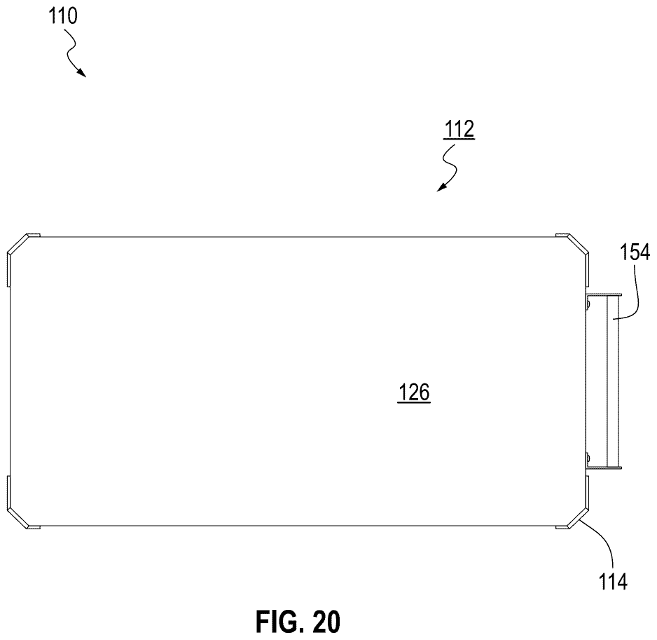

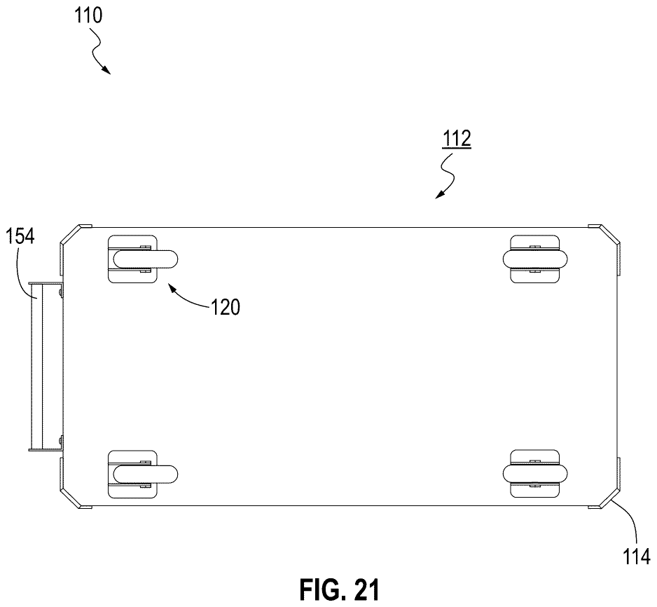

FIGS. 16 through 22 show another mobile system 110 and its tool cart 112 according to a further aspect of the disclosure. More particularly, a series of rails 114 with slots 116 are attached to the corners of the tool cart 112. The rails 112 may be mounted onto sides or corners of the toolbox 112 near a handle 152 for configurable quick access. This system 110 permits a technician to find storage for objects that do not typically fit within the toolbox 112, as well as the ability to move accessories—such as the power tool holder 38, the spool holder 40, the towel bar system 42, the cup holder 44, the parts holder 46, the hook device 48, and the phone holder 50 as described above—to different positions around the cart 112 to customize for a specific task or to accommodate individual preferences.

FIGS. 16 through 22 further show that the toolbox 112 may have tie-down apertures 118, may be mounted on rollers or wheels 120, and may include storage shelves, pockets, or areas 122, relatively smaller tool drawers 124, a latchable compartment 126, and relatively larger drawers or closets 174. As shown, the tool drawers 124 may include pulls or handles 128 to pull open and close the drawers 124. Further, the compartment 126 may have a closure, lid, or cover 132 and a lock 134 to protect valuable tools or instrumentation. By locking the lock 134 in this example, both the compartment 136 and the drawers 134 may be secured.

With particular reference to the rails 114 in FIGS. 16 through 22, those may be manufactured from steel or other hardened materials capable of withstanding rugged work environments. The rails 114 also may be bolted or permanently affixed to the cart 112, preferably at corners of the cart 112 as shown, for instance, in FIG. 16 with rivets, screws, or bolts 136 to assist in protecting the sides and faces of the cart 112 from contact damage, as well as for hanging accessories apart from the tool storage drawers 124, 174 and the lid 132.

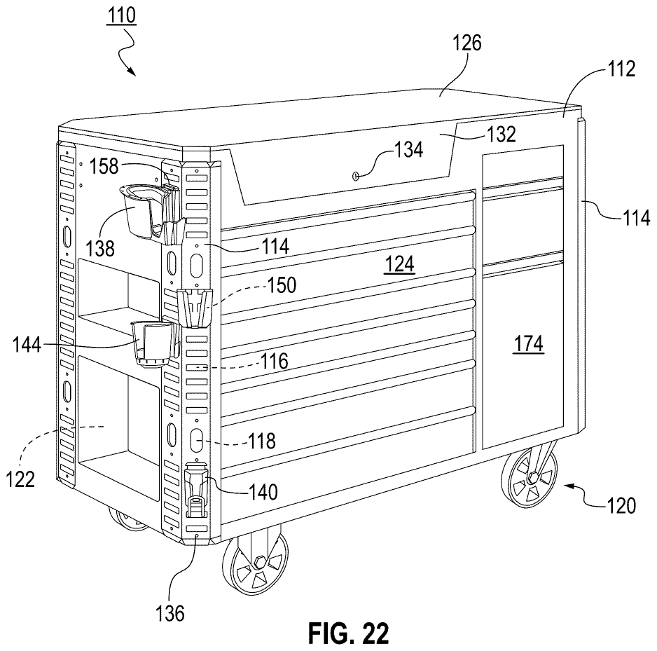

As most clearly shown in FIG. 22, the system 110 may be configured by a technician to accommodate personal preferences and to enable quick access to accessories as described above, all of which are quickly installed via apertures 116 on rails 114 of a tool cart 112. Thus, the system 110 permits the technician to store objects outside or around a perimeter of the toolbox 112 and to customize the toolbox 112 for a specific task.

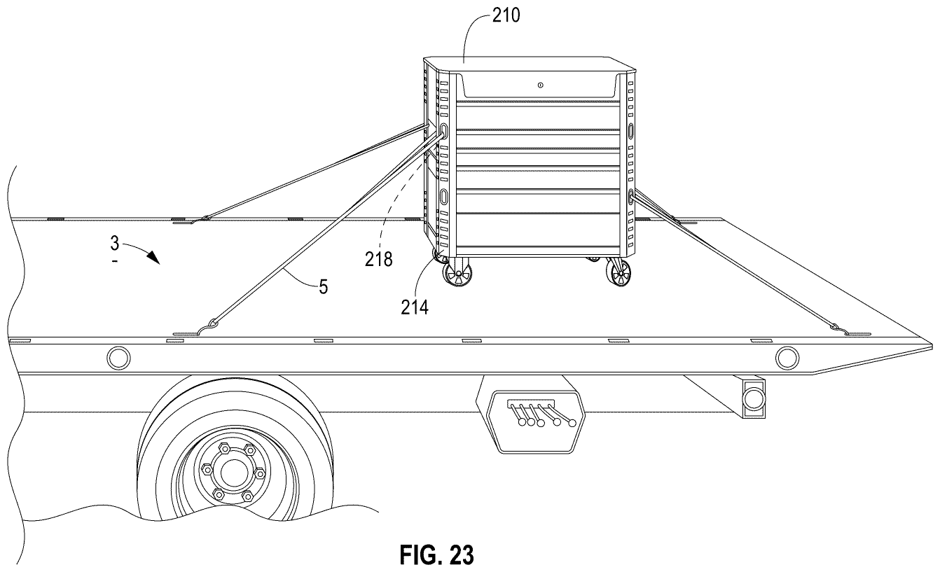

Turning to FIG. 23, a mobile tool cart system 210 is shown secured to truck bed 3 using ropes, chains, tie-downs, or straps 5 connected through or tied to various apertures 218 of the system 210. By forming the apertures 218 through corner rails 214, which may be made from steel or reinforced materials, the apertures 218 serve as sturdy tie-down points for the system 210 as, for instance, automobile technicians transit between jobs.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

By way of example and not of limitation, exemplary embodiments as disclosed herein may include but are not limited to:

EMBODIMENT 1: A mobile toolbox system comprises a toolbox having a plurality of wheels attached thereto, the frame being configured for positioning proximate a vehicle; a rail having a plurality of apertures formed therein, the rail disposed proximate a corner of the toolbox; and an accessory having means for connecting the accessory in at least one of the apertures, the accessory being configured to hold an item proximate a perimeter of the toolbox proximate a perimeter of the toolbox, the accessory being further configurable for repositioning to other apertures on the rail.

EMBODIMENT 2: The mobile toolbox system as in Embodiment 1, wherein the rail is made of steel.

EMBODIMENT 3: The method as in Embodiments 1 or 2, further comprising at least two rails disposed apart from each other at different corners of the toolbox.

EMBODIMENT 4: The mobile toolbox system as in Embodiments 1, 2, or 3, wherein the accessory is one of a phone holder, a hook, a towel bar, a power tool holder, a parts holder, a spool holder, and a cup holder.

EMBODIMENT 5: The mobile toolbox system as any Embodiment 1 through 4, wherein the plurality of apertures are spaced equidistant from each other.

EMBODIMENT 6: A method of customizing a mobile tool cart, comprising providing a toolbox having a plurality of wheels attached thereto, the toolbox being configured for positioning proximate a vehicle; attaching a rail to the toolbox, the rail having a plurality of apertures formed therein; providing at least one accessory; attaching the accessory to the rail; and placing a component in the accessory.

EMBODIMENT 7: The method as in Embodiment 6, wherein the rail is made of steel.

EMBODIMENT 8: The method as in Embodiments 6 or 7, wherein the rail is affixed to a corner of the toolbox, the rail being further configured to act as a damage guard.

EMBODIMENT 9: The method as in Embodiments 6, 7, or 8, wherein the accessory is one of a phone holder, a hook, a towel bar, a power tool holder, a parts holder, a spool holder, and a cup holder.

EMBODIMENT 10: The method as in Embodiments 6 through 9, further comprising attaching multiple accessories to the rails.

EMBODIMENT 11: A mobile toolbox kit, comprising a toolbox having a plurality of wheels attached thereto, the frame being configured for positioning proximate a vehicle; a rail having a plurality of apertures formed therein and spaced equidistant from each other, the rail disposed proximate a corner of the toolbox; and an accessory being connectable in at least one of the apertures, the accessory being configured to hold an item external to the toolbox and being selected from one of a phone holder, a hook, a towel bar, a power tool holder, a parts holder, a spool holder, and a cup holder.

EMBODIMENT 12: The mobile toolbox kit as in Embodiment 11, wherein the plurality of apertures are spaced equidistant from each other.

EMBODIMENT 13: The mobile toolbox kit as in Embodiments 11 or 12, wherein the accessory is at least two accessories disposed apart from each other.

EMBODIMENT 14: The mobile toolbox kit as in any of the foregoing embodiments, wherein the rail further comprises a tie-down aperture.

1. A mobile toolbox system, comprising:
a toolbox having a plurality of wheels attached thereto, the frame being configured for positioning proximate a vehicle;
a rail having a plurality of apertures formed therein, the rail disposed proximate a corner of the toolbox; and
an accessory having means for connecting the accessory in at least one of the apertures, the accessory being configured to hold an item proximate a perimeter of the toolbox, the accessory being further configurable for repositioning to other apertures on the rail.

2. The mobile toolbox system as in claim 1, wherein the rail is made of steel.

3. The mobile toolbox system as in claim 1, wherein the apertures are spaced equidistant from each other.

4. The mobile toolbox system as in claim 1, wherein the accessory is one of a phone holder, a hook, a towel bar, a power tool holder, a parts holder, a spool holder, and a cup holder.

5. The mobile toolbox system as in claim 1, wherein the means for connecting is a button and a plurality of latches, the button being configured to overcome a spring constant of each latch to urge each of the latches into respective engagement with the apertures.

6. The mobile toolbox system as in claim 1, further comprising a tie-down aperture formed in the rail and configured for receiving a strap to secure the toolbox for transport.

7. The mobile toolbox system as in claim 1, further comprising at least two rails disposed apart from each other at different corners of the toolbox.

8. A method of customizing a mobile tool cart, comprising:
providing a toolbox having a plurality of wheels attached thereto, the toolbox being configured for positioning proximate a vehicle;
attaching a rail to the toolbox, the rail having a plurality of apertures formed therein;
providing at least one accessory;
attaching the accessory to the rail; and
placing a component in the accessory.

9. The method as in claim 8, wherein the rail is made of steel.

10. The method as in claim 8, wherein the rail is affixed to a corner of the toolbox, the rail being further configured to act as a damage guard.

11. The method as in claim 8, wherein the accessory is one of a phone holder, a hook, a towel bar, a power tool holder, a parts holder, a spool holder, and a cup holder.

12. The method as in claim 8, further comprising attaching multiple accessories to the rails.

13. A mobile toolbox kit, comprising:
a toolbox having a plurality of wheels attached thereto, the frame being configured for positioning proximate a vehicle;
a rail having a plurality of apertures formed therein and spaced equidistant from each other, the rail disposed proximate a corner of the toolbox;
a tie-down aperture formed proximate the plurality of apertures; and
an accessory being connectable in at least one of the apertures, the accessory being configured to hold an item external to the toolbox and being selected from one of a phone holder, a hook, a towel bar, a power tool holder, a parts holder, a spool holder, and a cup holder, the accessory being further configurable for repositioning to other apertures on the rail.

14. The mobile toolbox kit as in claim 13, wherein the plurality of apertures are spaced equidistant from each other.

15. The mobile toolbox kit as in claim 13, wherein the accessory is at least two accessories disposed apart from each other.

16. The mobile toolbox kit as in claim 13, wherein the tie-down aperture is formed in the rail and configured for receiving a tie-down strap for securing the toolbox for transport.
